(19) United States
(12) Patent Application Publication
(10) Pub. No.: US 2014/0261646 A1
(43) Pub. Date: Sep. 18, 2014

(54) ADVANCED SEMICONDUCTOR-CONDUCTOR COMPOSITE PARTICLE STRUCTURES FOR SOLAR ENERGY CONVERSION

(71) Applicants: RESEARCH TRIANGLE INSTITUTE, Research Triangle Park, NC (US); DUKE UNIVERSITY, Durham, NC (US); NORTH CAROLINA STATE UNIVERSITY, Raleigh, NC (US); UNIVERSITY OF NORTH CAROLINA CHAPEL HILL, Chapel Hill, NC (US)

(72) Inventors: Paul G. HOERTZ, Morrisville, NC (US); Qing PENG, Cary, NC (US); Berc KALANYAN, Raleigh, NC (US); Do Han KIM, Cary, NC (US); Leila ALIBABAEI, Chapel Hill, NC (US); Jie LlU, Chapel Hill, NC (US); Thomas J. MEYER, Chapel Hill, NC (US); Gregory N. PARSON, Raleigh, NC (US); Jeffrey T. GLASS, Durham, NC (US); Mark LOSEGO, Durham, NC (US)

(73) Assignees: RESEARCH TRIANGLE INSTITUTE, Research Triangle Park, NC (US); DUKE UNIVERSITY, Durham, NC (US); NORTH CAROLINA STATE UNIVERSITY, Raleigh, NC (US); UNIVERSITY OF NORTH CAROLINA CHAPEL HILL, Chapel Hill, NC (US)

(21) Appl. No.: 14/218,270

(22) Filed: Mar. 18, 2014

Related U.S. Application Data
(60) Provisional application No. 61/794,959, filed on Mar. 15, 2013.

(51) Int. Cl. H01G 9/20

(52) U.S. Cl. CPC H01G 9/2036
USPC 136/254; 204/290.01; 204/290.12; 204/290.11; 204/290.14; 204/290.1

(57) ABSTRACT

An electrode for solar conversion including a porous structure configured to contain therein at least one of a catalyst, a chromophore, and a redox couple. The porous structure has a set of electrically conductive nanoparticles adjoining each other. The set of electrically conductive nanoparticles forms a meandering electrical path connecting the nanoparticles together. The porous structure has an atomic layer by layer deposited semiconductive coating disposed conformally on the electrically conductive nanoparticles to form an exterior surface for reception of charge carriers.

### CROSS REFERENCE TO RELATED APPLICATIONS

This application claims priority to U.S. provisional application No. 61/794,959 filed on Mar. 15, 2013, the entire contents of which are incorporated herein by reference. U.S. provisional application No. 61/794,959 is related to provisional U.S. Ser. No. 61/794,508 “SEMICONDUCTOR-CONDUCTOR COMPOSITE PARTICLE STRUCTURES FOR SOLAR ENERGY CONVERSION” filed Mar. 15, 2013, Attorney Docket No. 412864US-2025-2025-20, the entire contents of which are incorporated herein by reference.

### BACKGROUND OF THE INVENTION

1. Field of the Invention

The present invention is related to nanoparticles, nanoparticle structures, methods and devices for energy conversion.

2. Description of the Related Art

Solar energy, a clean and abundant energy source, is the ultimate solution to escalating global energy demands. Of all the carbon-neutral alternative energies, solar energy is arguably the only source that can meet and surpass the predicted additional 30 terrawatts that will be consumed by humans by the year 2050 while combating the ill effects of global warming. In one hour, the Earth receives more than enough energy from the Sun to supply humanity's annual needs. The issue then becomes: How do we as humans harness this seemingly endless energy supply in an economical and practical fashion?

Solar energy conversion can be broken down into two subsets: solar photonic and solar thermal. In solar thermal systems, sunlight is concentrated to build up enough heat to carry out chemical transformations or to vaporize fluids to turn turbines for electricity generation. These systems, for example, consist of fields of either large mirrors that reflect incident light onto a collector tower or a multitude of parabolic mirrors having tubes containing fluid at their focal point. These “solar farms” are currently built in regions that receive large amounts of solar irradiation, e.g. the Southwest U.S. In order for solar thermal to become a viable option, significant advances in the electrical grid must be made in order to minimize the power that is lost as the electricity is transferred over large distances.

Solar photonic devices, on the other hand, are more practical for on-site energy generation. Existing solar photonic energy conversion technologies almost exclusively rely on the direct conversion of sunlight to electricity with photovoltaic devices. In the fifty years since their arrival to the marketplace, there still exists an unfortunate tradeoff: high efficiency solar cells (e.g. Si, GaAs) are also the most costly.

The high cost stems from the need for high purity semiconductors and materials that minimize the recombination of free carriers (holes and electrons) that are created upon light absorption; higher defect densities result in lower charge separation yields due to recombination. A simple yet practical concern with all solar energy strategies is the fact that energy generation will fall to zero once the sun sets at night. Hence, in order for solar energy to take on a lion's share of the energy market in the future, humanity must develop reliable methods for storing solar energy so that it can be used hours later at night.

One way to overcome this issue is to convert the energy from the sun into chemical energy through the production of high energy solar fuels (e.g. hydrogen). In solar fuel production, the energy from the sun is utilized to drive endothermic, small molecule reactions. Two approaches are water splitting (i.e. photoconversion of renewable, abundant water into hydrogen and oxygen) and water reduction of carbon dioxide into methanol, methane, or hydrocarbons. Both processes are carbon-neutral and would alleviate global warming if applied at the global scale.

The energy stored in solar fuels can be harnessed either with electricity-generating fuel cells or through their combustion. Solar fuels bridge the gap between solar thermal and solar photonic technologies. Solar fuels can be formed and stock-piled at “solar farms” and then transported for use at power plants adjacent to communities. Alternately, solar fuels can be produced on-site for on-demand use or be stored for power generation at nighttime. Still another advantage of solar fuels is that they potentially can be used as transportation fuels in automobiles. Solar fuels are therefore a practical solution to the energy storage problem that plagues solar energy conversion.

Accordingly, there exists a critical need to have a solution or solutions addressing the short-comings in this field.

### SUMMARY OF THE INVENTION

In one embodiment of the present invention, there is provided an electrode for solar conversion including a porous structure configured to contain therein at least one of a catalyst, a chromophore, and a redox couple. The porous structure has a set of electrically conductive nanoparticles adjoining each other. The set of electrically conductive nanoparticles forms a meandering electrical path connecting the nanoparticles together. The porous structure has an atomic layer by layer deposited semiconductive coating disposed conformally on the electrically conductive nanoparticles to form an exterior surface for reception of charge carriers.

In one embodiment of the present invention, there is provided a solar conversion device including at least an anode and cathode made with the above-described electrode. The device includes a feedstock supply configured to supply feedstock into a region between the anode and cathode. The anode is configured to oxidize the feedstock. The cathode is configured to reduce constituents of the feedstock into a combustible fuel.

In one embodiment of the present invention, there is provided a method for fabricating the above-described electrode.

It is to be understood that both the foregoing general description of the invention and the following detailed description are exemplary, but are not restrictive of the invention.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. A more complete appreciation of the invention and many of the attendant advantages thereof will be readily obtained as the same becomes better understood by reference to the following detailed description when considered in connection with the accompanying drawings, wherein:

FIG. 1A is a schematic of a PV-water electrolyzer device;

FIG. 1B s a schematic of a single absorber photoelectrochemical cell;

FIG. 2A is a schematic of a nano-TiO₂ dye-sensitized solar cell (DSSC);

FIG. 2B is a schematic of a nano-TiO₂-based solar fuel device;

FIGS. 3A-C are schematic diagrams for synthesizing fluorine-doped tin oxide conductive glass on antimony tin oxideparticle FTO-nanoATO film supported TiO₂ photoelectrochemical PEC electrodes by atomic layer deposition (ALD);

FIGS. 4A-C are micrographs from SEM images of nanoATO film with a) 0, b) 200 cycles, and c) 600 cycles TiO₂ ALD coating;

FIG. 4D is a plot of roughness factors of FTO-nanoATO samples coated with different TiO₂ ALD cycles, measured by dye adsorption-desorption experiments; and

FIGS. 5A-D are graphs showing the photoelectrochemical performance of the constructed solar fuel cells.

FIG. 6 is a plot of a measured current density vs. voltage (J-E) curve of FTO-nanoATO electrodes; and

FIGS. 7A-B are graphs showing normalized transient photocurrent traces for various FTO-nanoATO electrodes under 355 nm pulsed irradiation.

### DETAILED DESCRIPTION OF THE INVENTION

The invention in one aspect provides conformal nanoscale coatings onto pre-assembled, three dimensional objects for the creation of multi-component composites. In one example, a semiconductor coated consolidated conducting nanoparticle structure provides a unique structure for electron transport and utilization where electrons generated in the semiconductive material from the optical absorption of energy and the generation of electron-hole pairs merely have to be transported across nanometers of material before being in a conductive (metallic-like) medium. The semiconductive coating on the conducting shell forms a core-shell structure. The consolidated conducting nanoparticle structure forms the basis of a porous structure having the semiconductive coating deposited thereon.

In general, this core-shell structure 1) promotes the transfer of electrons from the shell to the conductive core, 2) serves as a physical barrier between majority carriers being transported within the conductive core and minority carriers located on the surface of the porous structure or within the porous structure, and 3) controls the distance between charge carriers within conductive core and minority carriers located on the surface of the porous structure or within the porous structure, thereby controlling the kinetics of recombination. The higher charge carrier mobility of the conductive core and the core-shell structure favors transport and collection of electrons further impeding charge recombination. The core-shell structures also help prevent the core material from being corroded.

This invention thus provides a novel approach where materials for solar conversion are provided in a configuration in which absorption of solar energy generates electron-hole pairs and efficiently separates the electrons from the holes. In solar fuel-generating devices, this configuration results in the efficient utilization of the holes for oxidation reactions and efficient utilization of the electrons for reduction reactions. In solar cell devices, this configuration results in efficient establishment of a photovoltaic voltage and current source without the high cost and complexities associated with single crystal or polycrystalline solar cells. These gains in efficiency are particularly relevant for photocathodes based on porous structures.

Accordingly, in one aspect of the present invention, there is provided a novel electron transport medium (ETM) for solar fuel photoelectrochemical devices based on composite nanoparticle thin films. The novel nanoparticle thin films form high surface area support structures that can be employed as the ETM in photoanodes of working photoelectrochemical solar fuel devices. In one embodiment of this invention, the ETMs can serve as porous, high surface area supports onto which the light-harvesting and catalytic entities can be deposited.

Accordingly, in one aspect of the present invention, there is provided a novel hole transport medium (HTM) for solar fuel photoelectrochemical devices based on composite nanoparticle thin films. The novel nanoparticle thin films form high surface area support structures that can be employed as the HTM in photocathodes of working photoelectrochemical solar fuel devices. In one embodiment of this invention, the HTMs can serve as porous, high surface area supports onto which the light-harvesting and catalytic entities can be deposited.

As noted above, the creation of conformal semiconductor—continuous conductor core-shell nanostructures means that electrons only have to be transported over nanoscale lengths from the site of light absorption before reaching the conductor (L˜1-100 nm). In prior semiconducting nanoparticle thin film structures, the electron is transported along a longitudinal-direction through a series of semiconducting nanoparticles prior to reaching a planar transparent conducting oxide (TCO) electrode (average electron transport length ˜5-10 microns).

As noted above, in one embodiment of the invention, there is provided an electrode for solar conversion including a porous structure configured to contain therein at least one of a catalyst, a chromophore, and a redox couple. The porous structure has a set of electrically conductive nanoparticles adjoining each other. The set of electrically conductive nanoparticles forms a meandering electrical path connecting the nanoparticles together. The porous structure has an atomic layer by layer deposited semiconductive coating disposed conformally on the electrically conductive nanoparticles to form an exterior surface for reception of charge carriers.

As used herein, “meandering electrical path means a conducting path from one nanoparticle to another and then to adjacent nanoparticles, etc. The meandering path is not a straight line path across the entirety of the porous structure. The meandering path in one embodiment can constitute a set of random diverging pathways across the entirety of the porous structure. The meandering path in one embodiment can be a more ordered approach where the nanoparticles are or are approximately in an ordered packing arrangement and the meandering path connects from one nanoparticle to another within this ordered packing arrangement.

As used herein, “optically transparent” is defined as at least about 50% of visible light transmittance there through. In some embodiments, the optically transparent is at least about 70% of visible light transmittance there through.

As used herein, “electrode” or “conductive structure” refers to an electrical conductor used to make contact with a nonmetallic part of a circuit (e.g. a semiconductor, an electrolyte or a vacuum).

As used herein, “semiconductive” refers to the electrical property of materials such as Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh), and perovskite structures of the form ABX₃. other delafossite structured materials, as well as doped and composite versions of the above.

Charge transport in these materials is by electrons and/or holes. Various organic semiconductors include organic dyes, such as methylene blue and the phthalocyanines; aromatic compounds, such as naphthalene, anthracene, and violanthrene; polymers with conjugated bonds; some natural pigments, such as chlorophyll and n-carotene; charge-transfer molecular complexes; and ion-radical salts.

In some embodiments, the average diameter of nanoparticles is less than about 1000 nm. In other embodiments, the average diameter of the nanoparticles is less than about 500 nm. In other embodiments, the average diameter of the nanoparticles is less than about 100 nm. In other embodiments, the average diameter of the nanoparticles is less than about 50 nm.

To understand the significance of this approach, at present, there are three practical ways to make solar fuels:
1) PV-water electrolyzer: A series of photovoltaic devices harness sunlight and produce the photovoltage necessary to carry out the reduction-oxidation (redox) reactions at two separate electrodes (FIG. 1A);
2) Photoelectrochemical cells: These devices carry out all of the necessary functions for producing solar fuels (i.e. light absorption, charge separation, electron collection, and catalytic redox reactions at two separate electrodes that are attached with a wire (FIG. 1B);
3) Photocatalysis: These systems carry out the necessary functions within the same “electrode” (e.g. n-type semiconducting TiO₂ nanoparticles that transport electrons between light absorber/oxidation catalyst conjugates and nanoparticles for catalytic reduction).

One issue with the first approach (using PV-water electrolyzers) is that these electrolyzers require stacking three or more photovoltaic solar cells in series in order to satisfy the high over-potentials that are needed. Hence, the cost of the overall device is highly dependent on the cost of the photovoltaic solar cell units.

One issue with the second and third approaches is that photocatalysis has historically yielded very low (<1%) quantum yields for solar fuel generation, presumably due to the fact that the redox reactions are not compartmentalized. As a result, electron-hole recombination occurs quite readily prior to catalysis. A particular problem with one-electrode systems is the possibility that the generated fuels can recombine catalytically prior to leaving the system (e.g. H₂ and O₂ recombining for example at Pt nanoparticles).

As with natural photosynthesis, the physical separation of pertinent reduction-oxidation (redox) processes appears to be an important criterion. In the photoelectrochemical method shown in FIG. 1B, two separate electrodes are connected with a wire. In order for a two-electrode system to work, one electrode has to absorb the incident light, and the absorption of the electrode (or the material of or on the electrode) should have a significant overlap with the solar spectrum. For a planar electrode to absorb enough sunlight to be practical, the absorbing material needs to be thick enough so that the spectral part of the solar energy capable of producing electron-hole pairs is absorbed in that material.

FIG. 2A is a schematic of a dye-sensitized solar PV cell (DSSC). As shown in FIG. 2A, the red box represents a visible-light absorbing chromophoric dye molecule or sensitizer; D represents a solution-phase electron donor; and D⁺ represents an oxidized solution-phase electron acceptor.

This nanocrystalline approach of the invention avoids the cost of high-purity materials. Nanocrystalline films typically utilize a matrix of interconnected nanoparticles (e.g., 10-20 nm) which provides for very high overall surface areas (e.g., >100 m²/g). Since the overall surface area is high, the amount of absorbing material (e.g. organic or organometallic dye molecules, or sensitizers, that absorb visible-near IR, or quantum dots) that can be deposited is impressive (˜10⁻⁷ mol/cm²). Furthermore, nanocrystalline films containing a monolayer of dye molecules with reasonable extinction coefficients (10000-100000 M⁻¹cm⁻¹) can absorb essentially all visible-near IR incident photons.

NanoTiO₂ DSSCs allow for near unity incident-photon-to-current efficiencies (IPCEs); nearly all of the incident photons are absorbed by the surface-bound dye molecules within the ˜10 μm-thick nanoTiO₂ film and converted into electrons which are collected in the external circuit. The global efficiencies for these devices have reached an impressive 10-13%, limited mainly by their inability to harvest wavelengths longer than 800 nm.

FIG. 2B is a schematic of a nano-TiO₂-based solar fuel device. As shown in FIG. 2B, the red box represents a chromophore (e.g., a Ru bipyridyl complex or a Ru terpyridine complex), and the blue box represents a catalyst (e.g., Co₃O₄, IrO₂, molecular catalyst). The critical issue is that the electron diffusion length for nanoTiO₂ is large (˜10 μm) and films of this thickness are needed to absorb >90% of the incident light. These electron diffusion lengths are nonetheless possible with DSSCs because a redox couple (e.g., a iodine redox electrolyte) is present within the mesopores of the nano-TiO₂ to intercept any oxidized sensitizer that is formed after light absorption by the chromophore and excited state electron transfer from the chromophore to the conduction band of TiO₂. The redox couple further separates electrons and holes, thereby slowing down charge recombination between electrons being transported through the nanoparticle film and the oxidized redox couple.

However, for solar fuel production, redox couples are not practical because their use would introduce significant losses in the photovoltage necessary for achieving water oxidation catalysis. Oxidizing equivalents need to be transferred to catalysts that are within 2-3 nm from the nanoparticle surface. Because electrons and holes cannot be separated over large distances, recombination effectively competes with electrons transport through the nanoTiO₂ matrix, hence the reported low (e.g., <1%) efficiencies for nanoTiO₂ matrix solar fuel devices.

Accordingly, in a conventional working photoelectrochemical solar fuel device, photochemical excitation of surface-bound chromophores produces excited states which inject electrons into the adjacent semiconductor coating (e.g., TiO₂), leaving behind the oxidized chromophore; i.e. holes. The holes are then transferred to nearby electrocatalysts that activate the four-electron oxidation of water to protons and oxygen. For the semiconductor-conductor composite ETM of this invention, the injected electrons are transported across the conformal semiconducting layer into the conductive electron transport medium (CETM).

According to one embodiment of this invention, the CETM is a continuous array of fused, low-impedance conductive nanoparticles (e.g., ITO nanoparticles) that directs the electrons or holes to the underlying planar conductive substrate for extraction into an external circuit. The collected electrons or holes are then used at the counterelectrode as either reducing equivalents to, e.g., reduce protons to hydrogen solar fuel, or as oxidizing equivalents to, e.g. oxidized water to oxygen and protons. In this case, one electrode absorbs incident light and is a photoelectrode while the other is a non-light absorbing electrode.

In another embodiment, two photoelectrodes are used in a tandem cell.

By making the electron diffusion length vanishingly small and by controlling the thickness of the semiconductor shell (1-100 nm), parasitic electron-hole recombination rates are expected to plummet because of the following:
1) the CETM offers low impedance electron transport relative to all-semiconductor ETMs,
2) the semiconductor-conductor interface provides the potential for charge separation (electron-hole separation), and
3) the electron transfer rates decrease exponentially with distance (in this case, the distance should equal the thickness of the semiconducting layer).
4) the core-shell structure promotes the transfer of electrons from the shell to the conductive core due to the nanoscale thickness of the shell.
   The rectifying semiconductor-conductor interface of this nanostructure should reduce or prevent charge recombination and allow for the kinetically slow four-electron oxidation of water to proceed at electrocatalysts that are bound to a surface of the CETM.

Since the electron diffusion length no longer controls the thickness of the nanocrystalline film that can deliver electrons, unity incident light-harvesting efficiencies can be attained even with thicker nanoparticle films (>10 microns), in stark contrast to conventional approaches.

### Hybrid Semiconductor-Conductor Nanoparticle Electrodes

In one embodiment of the invention, the conductive material includes, but is not limited to, one of the following transparent conducting oxides (TCO): tin-doped indium oxide (ITO), antimony-doped tin oxide (ATO), fluorine-doped tin oxide (FTO), aluminum-doped zinc oxide (AZO), gallium-doped zinc oxide (GZO), and indium-doped zinc oxide (IZO).

In one embodiment of the invention, hybrid semiconductor-conductor nanoparticle electrodes are fabricated from colloidal suspensions of conductive nanoparticles (e.g. tin-doped ITO nanoparticles) which are deposited to form porous conductive films on planar TCO substrates, e.g., FTO or ITO. Films from the colloidal suspensions of conductive nanoparticles can be deposited via spin-coating or a doctor-blade method with tape-casting to set the thickness of a well between the tape. For spin-coating, the thickness of the film can be varied by controlling the concentration of nanoparticles in the suspension, the number of consecutive spins, and the spin rate. For the doctor-blade method, the thickness will be controlled by varying the number of tape layers on either side of the film.

The deposited films are then annealed to sinter the particles and minimize interparticle resistance. An important attribute of the resultant films is that electrical continuity exists throughout the entire thickness of the deposited nano-ITO film.

As described in the application “SEMICONDUCTOR-CONDUCTOR COMPOSITE PARTICLE STRUCTURES FOR SOLAR ENERGY CONVERSION” referenced above, a number of deposition methods can be used to coat the conductive nanoparticles and thereby form the semiconductor-conductor hybrid nanoparticle films and the semiconductor-conductor hybrid nanoparticle structures of the invention. Of these, this invention is directed to the use of atomic layer-by-layer deposition.

Atomic layer-by-layer deposition (ALD) is a deposition based on the sequential use of a gas phase chemical process. ALD reactions typically use two chemical precursors which react in a self-limiting manner. The precursors react with a surface one at a time in a sequential and self-limiting manner allowing two half-reactions to proceed sequentially, resulting in a sub-nanometer layer of a material to be formed in each reaction cycle. By exposing the precursors to the growth surface repeatedly, a thin film is deposited. The resulting material deposited is typically a combination of materials present in the separate reactants used.

ALD coating methods are suitable for the deposition of a wide variety of materials (insulators, semiconductors, conductors) including for example Si, TiO₂, ZnO, Nb₂O₅, SnO₂, and SrTiO₃ and many of the other “semiconductive” materials described above. Use of these materials allows for the tuning of a semiconductor's conduction band edge energy over a wide range, thereby altering the driving force for the reductive process at the cathode.

### Semiconductor-Conductor Hybrid Nanoparticle Electrodes

A solar fuel device requires three components: (1) a light-harvesting chromophore that absorbs sunlight to produce an initial charge-separated state consisting of an oxidized chromophore and a reduced electron acceptor (e.g. typically a semiconductor such as TiO₂), (2) an electron transport medium (ETM) that further separates the electrons and holes by selectively carrying the electrons to a catalyst for proton reduction, and (3) an electrocatalyst that uses the holes to oxidize water to produce protons and oxygen.

Accordingly, in one embodiment of this invention, there is provided a semiconductor shell nanostructure formed over one or more conductive cores in which electrons or holes only have to be transported over nanoscale lengths before reaching a conductor. By making the electron diffusion length vanishingly small, electron-hole recombination rates substantially decrease allowing for a sufficient supply of electrons to drive a four electron oxidation of water into protons and oxygen in a region in vicinity of the stacked array of conducting nanoparticles. Electrons at the second electrode can be used to reduce protons to hydrogen or for example to reduce carbon dioxide to methanol, methane, or hydrocarbons. Likewise, by making the hole diffusion length vanishingly small, electron-hole recombination rates substantially decrease allowing for a sufficient supply of electrons to drive a two electron reduction of water into hydrogen. Holes at the second electrode can be used to oxidize water into protons and oxygen.

As noted above, a photoelectrochemical solar fuel device can be a two electrode cell which converts light energy into chemical energy in the form of high energy fuels. Light absorption and initial charge separation can occur at either a photoanode containing n-type semiconducting material or a photocathode containing p-type semiconducting material. For a solar fuel cell having a photocathode, the electrons or reducing equivalents are passed to nearby catalysts which allow for the reduction of protons to evolve hydrogen or carbon dioxide to form various products (e.g. CO, methanol, methane). The holes are collected from the photocathode and passed via an external circuit to catalysts at the anode, where they can potentially oxidize water.

Antimony Doped Tin Oxide on Fluorine Doped Tin Oxide Glass Structures

In one embodiment of this invention, antimony doped tin oxide nanoparticle (nanoATO) films are formed on fluorine doped tin oxide glass (FTO-nanoATO) structures, with the FTO-nanoATO structures serving as a transparent conductive scaffold for nanostructured TiO₂ PEC electrodes. Antimony doped tin oxide (ATO) is a transparent conductor (E_{g}: 3.6-4.4 eV). It competes much less with TiO₂ for light absorption than previous electron transport materials, e.g., Si (E_{g}≈1.1 eV), TiSi₂ (E_{g}≈1.5 eV), and carbon.

Fabrication

The fabrication process detailed below follows closely the descriptions in the attached paper entitled “Solution-Processed, Antimony-Doped Tin Oxide Colloid Films Enable High-Performance TiO₂ Photoanodes for Water Splitting” by Peng et al. The entire contents of that paper (in the revised form submitted to Nano Letters and including the “Supporting Information”) are incorporated herein.

Antimony doped tin oxide nanoparticles of average particle size of 22-44 nm, (NanoTek®, purity of 99.5%) was purchased from Alfa Aesar and used without further purification. The weight ratio of Sb₂O₅:SnO₂ is 10:90 and the specific surface area of the particles are 20-40 m²/g. Dispersions of the nanoparticles were prepared with a solvent and surfactant and and using known techniques such ultrasonication and high-strength sonfiers. These dispersions were to prepare the porous nanoATO films (˜2 μm) on FTO glass. The FTO-nanoATO samples were then annealed in air at 500° C. for 1 h with a ramp rate of 5° C./min to form a good contact among the particles, as well as between the nanoATO film and the FTO substrate. The resistivity of the nanoATO films is around 40Ω□cm as analyzed by a four-point probe (Jandel Ltd) on quartz substrates.

Preparation of FTO-nanoATO/TiO₂ electrodes is illustrated in FIGS. 3A-C. Specifically, FIGS. 3A-C are schematic diagrams for synthesizing a FTO-nanoATO film by atomic layer deposition. In the process illustrated in this figure, at step a), a porous nanoATO film was first assembled onto FTO glass, FTO-nanoATO; at steps b) and c), conformal ALD TiO₂ films were applied onto FTO-nanoATO substrate, FTO-nanoATO/TiO₂.

The porous FTO-nanoATO film, as shown in FIG. 3A, was prepared by spin coating colloidal ATO nanoparticles (average diameter of 22-44 nm) on FTO glass followed by sintering at 500° C. in air. The resulting FTO-nanoATO film, ˜2 μm in thickness, is a bi-continuous porous network of pores and nanoparticles (see FIG. 4A).

As illustrated in FIGS. 3A-C, with TiO₂ shell thickness increasing, voids and interconnects inside of nanoATO scaffold became smaller and then sealed. For TiO₂ ALD, ALD on the substrates was carried out in a hot-wall tube reactor. In brief, TiO₂ ALD was performed at 300° C. with N₂ flow rate of 200 sccm. The process pressure was ˜1 Torr. The timing sequence for dose and purge of TiCl₄ and H₂O was 1.5/10 s and 1.5/10 s, respectively. Before commencing ALD deposition, samples were placed in the reactor for 30 mins under N₂ flow (200 sccm) to establish thermal equilibrium. The growth rate of TiO₂ ALD was monitored by witness silicon wafer samples. The TiCl₄ (99%) was purchased from Gelest Inc. and used as received. Deionized water from an onsite water purification system was used as the water source. Ultrahigh purity N₂ (99.999%) from National Welders was used as both carrier and purge gas and further purified by a filter (Gatekeeper®).

To assemble the substrates into photoelectrochemical (PEC) electrodes, ohmic electric contacts to TiO₂ coated FTO-nanoATO and FTO glass substrates and FTO-nanoTiO₂ film were made by rubbing a Ga—In eutectic on part of the FTO surface of the substrates. Electrical connection was made to the sample by contacting this eutectic with a copper wire, which was then sealed with nonconductive epoxy (Hysol® 9460, Loctitte.) at the end of a glass tubing through which the Cu wire had been directed such that the surface-normal of the substrate was perpendicular to the glass tubing. Epoxy (Hysol® 9460, Loctitte.) was then used to define the active area of electrodes (˜1 cm²), and cured under a heating gun at ˜80° C. in ambient environment. The active area of the photoelectrodes was measured with ImageJ software by using the photo images of the electrodes.

Testing

All electrochemical measurements were performed in a custom fabricated PTFE cell having quartz windows on both sides using a three-electrode configuration and all electrodes were inside the electrochemical cell. A Potentiostat/Galvanostat system (Model 1287A by Solartron Analytical) was used for cyclic voltammetry (CV) measurement, in which the potential was swept from −1.2 V to 1.0 V vs. Ag/AgCl reference electrode at a scan rate of 20 mV/s. The reference electrode was Ag/AgCl in 3.5M KCl solution (Hanna instruments Inc.). Pt gauze (100 mesh, 99.95% purity Alfa Aesar Co.) served as the counter electrode. All electrodes were tested in 1M KOH solution (pH=13.6), which was continuously bubbled with ultrahigh purity Ar (National Welders) to remove oxygen and H₂ from the solution.

Prior to measuring the photocurrent, CV scans between −1.2 V and 1.0 V vs. Ag/AgCl with a Pt wire electrode were performed 10 times to eliminate impurities. For photoelectrochemical analysis, the light source used was a Newport Oriel Xe lamp with AM1.5G filter. The light intensity was calibrated between measurements so that a photoelectrode produced an equivalent photocurrent density to that obtained under 100 mW/cm² of AM1.5G illuminations. Optical filters of CGA320, CGA400, and CGA550 (Newport Inc.) were used to filter the light through with the cut-on wavelength of 320, 400 and 500 nm respectively. The tolerance of cut-on wavelength is ±5 nm. The optical transmittance of the filters is >90%. In the long term stability testing, the potential of the testing electrode stay at −1.0 V and 0.5 V vs. Ag/AgCl for 100 s alternatively for more than 4 days under irradiation.

Transient photocurrent measurements were acquired by using a CH Instruments Model 600D Series Electrochemical Workstation. A two-compartment photoelectrochemical cell, with a glass fit spacer, was employed for both photocurrent and transient absorption measurements. The working electrode, FTO-nanoATO, FTO-nanoATO/TiO₂(200), and FTO-nanoTiO₂ film were placed at a 45° angle into the first compartment, a 10 mm path length square cuvette, with a platinum wire counter electrode. The Ag/AgCl reference electrode (BASi, MF-2079) was placed in the second compartment. Both compartments were filled with aqueous 1.0 M KOH, and the entire system was kept under a N₂ environment. Current-time traces were acquired for 10 s (0.1 ms per data point) with 0 V applied bias vs. Ag/AgCl. Laser excitation (λₑₓ=355 nm, 8.0 mJ/pulse), at a repetition rate of 1 Hz, was incident perpendicular to the cuvette and at a 45° angle to the working electrode.

Results

In one aspect of this invention, the photoelectrodes of FTO-nanoATO with s semiconductive TiO₂ shell (FTO-nanoATO/TiO₂) synthesized by atomic layer deposition (ALD) have shown significant improvements in photocurrent density relative to planar electrodes of TiO₂ ALD film-coated FTO glass (FTO/TiO₂). Although the porous nanoATO films have a less defined conduction pathways and presumably larger defect densities than “forests” of single crystal Si nanowires and TiSi₂ nanonets, the resultant photocurrent densities were comparable. The thickness of the ALD TiO₂ photo-absorbing film was found to be an important factor in determining PEC performance.

FIGS. 4A-C are micrographs from SEM images of nanoATO film with a) 0, b) 200 cycles, and c) 600 cycles TiO₂ ALD coating. The solid arrows in FIGS. 4A-C point to the relatively large pores in the nanoparticle films. The dashed arrows point to small diameter pores. FIG. 4D is a plot of roughness factors of FTO-nanoATO samples coated with different TiO₂ ALD cycles, measured by dye adsorption experiments. Error bar is from the standard deviation of two measurements from different samples. The results indicate that a conformal layer of TiO₂ was coated onto the FTO-nanoATO substrate by ALD.

More specifically, FIG. 4A shows the morphology of pure nanoATO film on FTO glass obtained by SEM. The SEM measurement shows that the majority of particles have diameters <50 nm. A small fraction of large particles (diameter of ˜100 nm) also existed in the films. In the film, ATO nanoparticles bind together during the calcination step to form a bi-continuous network of the metal oxide material and pores.

The morphology of a nanoATO film coated with 200 TiO₂ ALD cycles is seen in FIG. 4B. The thickness of the TiO₂ coating is estimated to be ˜9 nm. By comparison with FIG. 4A, it is seen that the average size of particles is increased due to the ALD coating. The increase in average particle size is larger than expected given the estimated TiO₂ thickness, which is due to a “wrapping effect” of the TiO₂ ALD coating.

In a substrate site-limited growth mode, TiO₂ ALD coatings gradually seals pores of small diameters between individual particles. Further TiO₂ ALD coating can only grow around the external surface of the bonded nanoparticles and bury the boundary between individual nanoparticles. This results in a merging of the individual nanoparticles into a cluster of irregular shape with a relatively smooth surface or the TiO₂ ALD “wraps” nanoparticles within the coating. In the meantime, the pores with large diameters are maintained.

When ALD TiO₂ shell thicknesses are increased further to ˜30 nm, with 600 ALD cycles, the thick TiO₂ shell sealed most of the pores and interconnects in the nanoATO film. The particle-like features in FIG. 4C were not as clear as those in FIG. 4B owing to the smoothing effect caused by the thick coating. This phenomenon is more apparent for nanoATO films coated with 2000 TiO₂ cycles.

The roughness factors of the FTO-nanoATO substrates before and after ALD coatings were measured by dye adsorption-desorption experiments and the results are shown in FIG. 4D. According to these measurements, the roughness factor of the nanoATO films decreases with increasing thickness of the TiO₂ shell. For example, with a 100 cycle TiO₂ ALD coating, the roughness factor of the resulting nanoATO film is 117±5. This value decreased to 70±8 with increasing TiO₂ ALD cycles to 200 and further decreased to 44±6 at 300 ALD cycles. The measured roughness factor of FTO-nanoATO film (74±17) is smaller than that of FTO-nanoATO film coated with 100 TiO₂ ALD cycles (117±5).

FIGS. 5A-D are graphs showing the electrical performance of the constructed cells. FIG. 5A depicts current density (J) vs. Potential (E) under illumination for planar FTO/TiO₂ PEC electrode (middle line) and FTO-nanoATO/TiO₂ electrodes (upper line), as well as J-E curve in the dark (lower line). For both electrodes, 200 cycles of TiO₂ ALD coating were applied. FIG. 5B depicts the photocurrent densities (E=0 V vs. Ag/AgCl) of FTO-nanoATO/TiO₂ electrodes (Φ) and planar FTO/TiO₂ electrodes (□) with different TiO₂ cycles. Lines have been added as guides for the eyes.

FIG. 5C depicts J-E curve of FTO-nanoATO/TiO₂ electrodes irradiated by the light source through different optical filters. Most of the photocurrent is from photon of wavelength between 400 nm and 320 nm. FIG. 5D depicts the stability of the photocurrent density for FTO-nanoATO/TiO₂(200) electrode (E=0.5 V vs. Ag/AgCl).

Current density (J) vs. applied potential (E) (J-E) curves for FTO-nanoATO and FTO coated with 200 TiO₂ ALD cycles, in the dark and under illumination are presented in FIG. 5A. These two electrodes are referred to as FTO-nanoATO/TiO₂(200) and FTO/TiO₂(200) respectively, with 200 as the ALD cycle number. For both electrodes, the onset photocurrent potentials appear at −0.9 V vs. Ag/AgCl. This suggests that the observed photocurrents are from photo-excited TiO₂. The photocurrent density of the FTO-nanoATO/TiO₂(200) electrode (0.58 mA/cm² at 0 V vs. Ag/AgCl) is more than 6× that of the planar FTO/TiO₂(200) (0.09 mA/cm²), and an order of magnitude higher than the electrode of FTO-nanoTiO₂ film (TiO₂ nanoparticle diameter of ˜20 nm and film thickness of ˜6 μm on FTO glass). FTO-nanoATO electrodes without TiO₂ coatings had negligible photocurrent densities as shown in FIG. 6, which is consistent with the large band gap of ATO. It is noteworthy that at 0 V vs. Ag/AgCl (pH=14) the current is from PEC water oxidation with the formal potential for this reaction at ˜0.2 V vs. Ag/AgCl at pH=14.

The photocurrent densities (at 0 V vs. Ag/AgCl) of FTO-nanoATO/TiO₂ electrodes with different TiO₂ ALD cycles (i.e., 100, 175, 200, 300, 600, 1000, 1600, and 2000 cycles) are summarized in FIGS. 5A-B.

Based on these results, the electrode of FTO-nanoATO/TiO₂(200) had the highest photocurrent density, 0.58 mA/cm². Electrodes FTO-nanoATO/TiO₂ with 100 and 175 ALD cycles showed smaller photocurrent densities. An FTO-nanoATO/TiO₂(300) electrode with a thicker TiO₂ shell (i.e., ˜12 nm, 300 ALD cycles) had a smaller photocurrent density (0.32 mA/cm²) even with more TiO₂ loaded onto the FTO-nanoATO scaffold. The photocurrent density fell further with increasing TiO₂ shell thickness (i.e., 30 nm, 600 ALD cycles).

The photocurrent densities (0 V vs. Ag/AgCl) increased with TiO₂ ALD cycles up to 1000 cycles, i.e., ˜50 nm thick TiO₂ coating, and then decreased as the TiO₂ thickness was increased further. The maximum photocurrent density of ˜0.2 mA/cm² was obtained for samples FTO/TiO₂(1000), which is ˜35% of the largest photocurrent density (0.58 mA/cm²) obtained for the electrode of FTO-nanoATO/TiO₂(200), ˜9 nm TiO₂ shell.

Photocurrent densities of FTO-nanoATO/TiO₂(200) under illumination but with optical filters of different cut-off wavelengths are presented in FIG. 5C. These measurements show that more than 95% of the photocurrent results from irradiation at <400 nm. The photocurrent produced from irradiation at >550 nm is essentially zero. The results from FIG. 5C corroborate that the photocurrent from FTO-nanoATO/TiO₂(200) electrode was mainly produced from UV excited TiO₂.

The photochemical stability of the FTO-nanoATO/TiO₂(200) film was measured by monitoring the photocurrent density under illumination over the course of more than 4 days and the results are presented in FIG. 5D. There was a nominal decrease in the current response from FTO-nanoATO/TiO₂ photoelectrode over the course of the measurement suggesting that the electrode is stable under operating conditions in 1M KOH aqueous solution. In comparison, the ATO nanoparticles in the untreated FTO-nanoATO film desorbed from the glass substrate within 5 h in the testing electrolyte.

Based on these comparisons, the stable photocurrent densities in FIG. 5D also show that the thin TiO₂ ALD layer is conformal and pinhole free and protects the underlying nanoATO film. Otherwise fluctuation of current density would have been observed due to dissolution of ATO nanoparticles and delamination of the TiO₂ shells over the more than 4 day testing period.

The normalized transient photocurrent traces (at 0 V vs. Ag/AgCl) for FTO-nanoATO, FTO-nanoATO/TiO₂(200) and FTO-nanoTiO₂ film electrodes under 355 nm pulsed irradiation are shown in FIG. 7A. For the FTO-nanoTiO₂ film electrode, the transient photocurrent returns to baseline within 0.02 s of excitation. In contrast, the transient current for both the FTO-nanoATO and FTO-nanoATO/TiO₂(200) has a relatively slow decay that does not return to baseline even after 0.2 s. The relatively long lived current suggests that the charge carriers have much longer lifetime in the FTO-nanoATO/TiO₂(200) electrode compared to the FTO-nanoTiO₂ film. It is interesting to note that the normalized transient current decay of FTO-nanoATO is similar to FTO-nanoATO/TiO₂(200) albeit with a much smaller initial photocurrent.

The results of transient absorption measurements on FTO-nanoTiO₂ films and FTO-nanoATO/TiO₂(200) electrodes under 355 nm pulsed irradiation (at 0 V vs. Ag/AgCl) can be seen in FIG. 7B. The probe wavelength, 460 nm, was chosen because it is the absorption signature for holes in TiO₂. Transient decays for both FTO-nanoTiO₂ film and FTO-nanoATO/TiO₂(200) are similar with >10% of the initial signal extending out to more than 100 microseconds. The transient absorption signal from FTO-nanoATO was too small for meaningful interpretation owing to the large band gap of ATO.

The normalized transient photocurrent measurements in FIG. 7A show that FTO-nanoATO/TiO₂(200) has a significantly longer-lived transient photocurrent than the FTO-nanoTiO₂. The longer-lived photocurrent is indicative of significantly slowed charge recombination in FTO-nanoATO/TiO₂(200) and a longer lifetime for the photogenerated holes.

Given these observations, the dramatic improvement in photocurrent densities for FTO-nanoATO/TiO₂(200) can be attributed to the improved lifetime of holes and reduction of charge recombination. This is a direct consequence of the enhanced electron transport kinetics electron collection efficiency by the underlying conductive nanoATO film followed by rapid loss under bias. The can be attributed to the significant reduction in the electron transfer distance in the thin TiO₂ film to the underlying ATO nanoparticle collector electrode.

As in a typical DSSC, the photocurrent density of FTO-nanoATO/TiO₂ is greatly enhanced by the large surface area of the porous, nanostructured electrodes. As shown in FIG. 5B, the planar FTO/TiO₂ electrode has a maximal photocurrent density at a thickness of ˜50 nm corresponding to 1000 ALD cycles. Given the optical absorption coefficient α of ˜1.2 μm⁻¹ for photons at 370 nm, a TiO₂ layer ˜2 μm thick is needed to absorb >90% of UV photons.

Therefore, the reduced photocurrent density with increased TiO₂ coating thickness is at least in part due to the increased degree of charge recombination resulting from longer average electron and hole transfer distance to the collector electrode and semiconductor-electrolyte interface, respectively. In this configuration, the fast charge recombination seems to have offset the increased population of photoexcited carriers within the thick TiO₂ layer (>50 nm).

In contrast to the planar FTO/TiO₂ electrodes, the large surface area of FTO-nanoATO film supports (roughness factors >120) dramatically increases the loading of TiO₂ at a given TiO₂ ALD cycles. As a result, the FTO-nanoATO/TiO₂ electrodes absorb much more light than the planar FTO/TiO₂ PEC electrodes having the similar thickness of TiO₂ ALD layer.

Simultaneously, the thin coating of TiO₂, e.g., ˜9 nm from 200 ALD cycles, on the interconnected porous structure of the conductive FTO-nanoATO films, provide an average diffusion length for photo-produced holes similar to the TiO₂ coating thickness. This geometric feature greatly facilitates efficient diffusion of photoholes to the interface between TiO₂ and the external electrolyte.

While not limited to the following, it is believed that, when the TiO₂ ALD coating is relatively thin, the interconnected pores throughout the nanoATO film is maintained so that electrolyte is free to diffusion through the porous network. In this case, the average transport length of photoholes to the TiO₂/electrolyte interface is comparable to the TiO₂ coating thickness because the photoholes react with the electrolyte within the nearby pores. This allows the photocurrent density of the FTO-nanoATO/TiO₂ PEC electrodes to increase as TiO₂ shell thickness increases up to ˜9 nm due to (i) increased light absorption and (ii) a better crystallinity of the film compared to lower thicknesses.

As the TiO₂ thickness increases beyond 9 nm, the TiO₂ coating seals more and more pores, thereby reducing surface area and diffusion of electrolyte into the film. Under these conditions, a significant fraction of photoholes must travel to the top surface of the FTO-nanoATO/TiO₂ film to access the electrolyte for water oxidation. This increases the average transport length of photoholes from the TiO₂ coating from the nm to μm scale. This is much larger than the effective hole diffusion length in the ALD TiO₂ coating (˜-50 nm). Thus, the probability of charge recombination in the FTO-nanoATO/TiO₂ PEC electrodes increases, which reduces the photocurrent density. This mechanism is supported by the fact that the photocurrent density decreased further with increasing TiO₂ shell thickness (i.e., ˜30 nm, 600 TiO₂ cycles), as increasing numbers of pores sealed or blocked from electrolyte by the thick coating.

Generalized Aspects of the Invention

The following numbered statements reflect various generalized aspects of this invention.

Statement 1. An electrode for solar conversion, comprising: a porous structure configured to contain therein at least one of a catalyst, a chromophore, and a redox couple, the porous structure including, a set of electrically conductive nanoparticles adjoining each other, said set of electrically conductive nanoparticles forming a meandering electrical path connecting the nanoparticles together, an atomic layer by layer deposited semiconductive coating having a thickness less than 200 nm and disposed conformally on the electrically conductive nanoparticles to form an exterior surface for reception of charge carriers.

Statement 2. The electrode of statement 1, wherein the atomic layer by layer deposited semiconductive coating comprises tin oxide formed on antimony-doped tin oxide conductive nanoparticles.

Statement 3. The electrode of statement 2, wherein the porous structure including the set of electrically conductive nanoparticles and the atomic layer by layer deposited semiconductive coating has a photocurrent density between 0.2 mA/cm² and 0.58 mA/cm² under 100 mW/cm² of AM1.5G illumination.

Statement 4. The electrode of statement 1, wherein the semiconductive coating has a thickness less than 50 nm.

Statement 5. The electrode of statement 1, wherein the semiconductive coating has a thickness less than 10 nm.

Statement 6. The electrode of statement 1, wherein the semiconductive coating has a thickness between 1 nm and 10 nm.

Statement 7. The electrode of statement 1, wherein the semiconductive coating comprises a material which absorbs solar radiation.

Statement 8. The electrode of statement 1, wherein the semiconductive coating comprises at least one of Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh), and perovskite structures of the form ABX₃.

Statement 9. The electrode of statement 1, wherein the semiconductive coating comprises at least one of a p-type and n-type material.

Statement 10. The electrode of statement 1, wherein said chromophore comprises at least one of a monomer, an oligomers and a polymer.

Statement 11. The electrode of statement 9, wherein said chromophore comprises at least one of a porphyrin, a pyrene, a perylene, a xanthene, a phthalocyanine, a coumarin, a rhodamine, a buckminsterfullerene, a thiophene, a transition metal polypyridyl complex, a ferrocene, a methyl viologen, a donor-acceptor dye, and combinations thereof.

Statement 12. The electrode of statement 1, wherein said catalyst is attached to the chromophore, attached to the semiconductive coating, or located in solution within the pores of the porous structure.

Statement 13. The electrode of statement 1, wherein the catalyst comprises at least one of iridium, iron, cobalt, ruthenium, osmium, nickel, manganese, platinum, palladium, a transition metal, a transition metal oxide, or a transition metal complex.

Statement 14. The electrode of statement 1, wherein the exterior surface of the set of electrically conductive nanoparticles comprises a surface area in a range between 5 and 400 m²/gm.

Statement 15. The electrode of statement 1, wherein the electrically conductive nanoparticles comprise at least one of zinc-doped tin oxide, tin-doped indium oxide, fluorine-doped tin oxide, antimony tin oxide, gallium zinc oxide, indium zinc oxide, copper aluminum oxide, fluorine-doped zinc oxide, Sr₂Cu₂O₂, a doped delafossite conducting oxide material based on CuMO₂ (where M=Al, Ga, Cr, Fe, In, Y, B, Sc, Mn, Co, Rh), graphene, carbon, aluminum zinc oxide, organic dyes, aromatic compounds, organic conducting polymers, polymers with conjugated bonds, and charge-transfer molecular complexes.

Statement 16. The electrode of statement 1, wherein the electrically conductive nanoparticles have an average diameter ranging from 10 to 1000 nm.

Statement 17. The electrode of statement 1, wherein the electrically conductive nanoparticles have an average diameter ranging from 50 to 200 nm.

Statement 18. The electrode of statement 1, wherein the electrically conductive nanoparticles have an average diameter ranging from 20-80 nm.

Statement 19. The electrode of statement 1, wherein the porous structure has a porosity ranging from 50 to 90%.

Statement 20. The electrode of statement 1, wherein the porous structure comprises a coating on a base of the electrode.

Statement 21. The electrode of statement 1, wherein the porous structure comprises at least one stack extending vertically from a base of the electrode.

Statement 22. A solar conversion device comprising: an anode and a cathode at least one which comprises the electrode of any one of statements 1-21 and includes said porous structure; at least one of the anode and the cathode comprising a photoelectrode.

Statement 23. The solar conversion device of statement 22, wherein at least one of the anode and the cathode comprises a transparent electrode.

Statement 24. The solar conversion device of statement 22, further comprising: a feedstock supply configured to supply a feedstock into a region between the anode and cathode; the anode configured to oxidize the feedstock; and the cathode configured to reduce constituents of the feedstock into a combustible fuel.

Statement 25. The solar conversion device of statement 22, wherein said chromophore of statement 1 is attached to the photoelectrode for absorption of solar light and injection of charge carriers into the porous structure.

Statement 26. The device of statement 22, wherein said chromophore and redox couple of statement 1 are disposed within the anode and cathode and comprise a dye-sensitized solar cell.

Statement 27. The device of statement 26, wherein the chromophore is on the exterior surface of the semiconductive coating, and the redox couple electrolyte is disposed inside pores of the porous structure.

Statement 28. A solar conversion device comprising: a first electrode including the electrode of any one of statements 1-21. Statement 29. The device of statement 28, further comprising a second electrode having a non-porous structure.

Numerous modifications and variations of the present invention are possible in light of the above teachings. It is therefore to be understood that within the scope of the appended claims, the invention may be practiced otherwise than as specifically described herein.

1. An electrode for solar conversion, comprising:
a porous structure configured to contain therein at least one of a catalyst, a chromophore, and a redox couple, the porous structure including,
a set of electrically conductive nanoparticles adjoining each other,
said set of electrically conductive nanoparticles forming a meandering electrical path connecting the nanoparticles together,
an atomic layer by layer deposited semiconductive coating having a thickness less than 200 nm and disposed conformally on the electrically conductive nanoparticles to form an exterior surface for reception of charge carriers.

2. The electrode of claim 1, wherein the atomic layer by layer deposited semiconductive coating comprises tin oxide formed on antimony-doped tin oxide conductive nanoparticles.

3. The electrode of claim 2, wherein the porous structure including the set of electrically conductive nanoparticles and the atomic layer by layer deposited semiconductive coating has a photocurrent density between 0.2 mA/cm² and 0.58 mA/cm² under 100 mW/cm² of AM1.5G illumination.

4. The electrode of claim 1, wherein the semiconductive coating has a thickness less than 50 nm.

5. The electrode of claim 1, wherein the semiconductive coating has a thickness less than 10 nm.

6. The electrode of claim 1, wherein the semiconductive coating has a thickness between 1 nm and 10 nm.

7. The electrode of claim 1, wherein the semiconductive coating comprises a material which absorbs solar radiation.

8. The electrode of claim 1, wherein the semiconductive coating comprises at least one of Si, GaAs, Ge, GaN, GaP, CdS, CdSe, TiO₂, ZnO, Ta:TiO₂, Nb₂O₅, SnO₂, WO₃, Fe₂O₃, SrTiO₃, BaTiO₃, NiO, Cu₂O, MoO₃, CuMO₂ (where M=Al, Ga, Cr, Fe, In, Y, B, Sc, Mn, Co, Rh), and perovskite structures of the form ABX₃.

9. The electrode of claim 1, wherein the semiconductive coating comprises at least one of a p-type and n-type material.

10. The electrode of claim 1, wherein said chromophore comprises at least one of a monomer, an oligomers and a polymer.

11. The electrode of claim 9, wherein said chromophore comprises at least one of a porphyrin, a pyrene, a perylene, a xanthene, a phthalocyanine, a coumarin, a rhodamine, a buckminsterfullerene, a thiophene, a transition metal polypyridyl complex, a ferrocene, a methyl viologen, a donor-acceptor dye, and combinations thereof.

12. The electrode of claim 1, wherein said catalyst is attached to the chromophore, attached to the semiconductive coating, or located in solution within the pores of the porous structure.

13. The electrode of claim 1, wherein the catalyst comprises at least one of iridium, iron, cobalt, ruthenium, osmium, nickel, manganese, platinum, palladium, a transition metal, a transition metal oxide, or a transition metal complex.

14. The electrode of claim 1, wherein the exterior surface of the set of electrically conductive nanoparticles comprises a surface area in a range between 5 and 400 m²/gm.

15. The electrode of claim 1, wherein the electrically conductive nanoparticles comprise at least one of zinc-doped tin oxide, tin-doped indium oxide, fluorine-doped tin oxide, antimony tin oxide, gallium zinc oxide, indium zinc oxide, copper aluminum oxide, fluorine-doped zinc oxide, Sr₂Cu₂O₂, a doped delafossite conducting oxide material based on CuMO₂ (where M=Al, Ga, Cr, Fe, In, Y, B, Sc, Mn, Co, Rh), graphene, carbon, aluminum zinc oxide, organic dyes, aromatic compounds, organic conducting polymers, polymers with conjugated bonds, and charge-transfer molecular complexes.

16. The electrode of claim 1, wherein the electrically conductive nanoparticles have an average diameter ranging from 10 to 1000 nm.

17. The electrode of claim 1, wherein the electrically conductive nanoparticles have an average diameter ranging from 50 to 200 nm.

18. The electrode of claim 1, wherein the electrically conductive nanoparticles have an average diameter ranging from 20-80 nm.

19. The electrode of claim 1, wherein the porous structure has a porosity ranging from 50 to 90%.

20. The electrode of claim 1, wherein the porous structure comprises a coating on a base of the electrode.

21. The electrode of claim 1, wherein the porous structure comprises at least one stack extending vertically from a base of the electrode.

22. A solar conversion device comprising:
an anode and a cathode at least one of which comprises;
a porous structure configured to contain therein at least one of a catalyst, a chromophore, and a redox couple, the porous structure including,
a set of electrically conductive nanoparticles adjoining each other,
said set of electrically conductive nanoparticles forming a meandering electrical path connecting the nanoparticles together, and
an atomic layer by layer deposited semiconductive coating having a thickness less than 200 nm and disposed conformally on the electrically conductive nanoparticles to form an exterior surface for reception of charge carriers; and
at least one of the anode and the cathode comprising a photoelectrode.

23. The solar conversion device of claim 22, wherein at least one of the anode and the cathode comprises a transparent electrode.

24. The solar conversion device of claim 22, further comprising:
a feedstock supply configured to supply a feedstock into a region between the anode and cathode;
the anode configured to oxidize the feedstock; and
the cathode configured to reduce constituents of the feedstock into a combustible fuel.

25. The solar conversion device of claim 22, wherein
said chromophore is attached to the photoelectrode for absorption of solar light and injection of charge carriers into the porous structure.

26. The device of claim 22, wherein said chromophore and redox couple are disposed within the anode and cathode and comprise a dye-sensitized solar cell.

27. The device of claim 26, wherein
the chromophore is on the exterior surface of the semiconductive coating, and
the redox couple electrolyte is disposed inside pores of the porous structure.

28. A solar conversion device comprising:
a first electrode including;
a porous structure configured to contain therein at least one of a catalyst, a chromophore, and a redox couple, the porous structure including,
a set of electrically conductive nanoparticles adjoining each other,
said set of electrically conductive nanoparticles forming a meandering electrical path connecting the nanoparticles together, and
an atomic layer by layer deposited semiconductive coating having a thickness less than 200 nm and disposed conformally on the electrically conductive nanoparticles to form an exterior surface for reception of charge carriers.

29. The device of claim 28, further comprising a second electrode having a non-porous structure.
